(19) United States
(12) Patent Application Publication
(10) Pub. No.: US 2010/0052201 A1
(43) Pub. Date: Mar. 4, 2010

(54) FOAMED CELLULAR PANELS AND RELATED METHODS

(75) Inventor: Krishna Nadella, Seattle, WA (US)

Correspondence Address: THOMAS LOOP, P.O. BOX 21466, SEATTLE, WA, 98111, US

(73) Assignee: MicroGREEN Polymers, Inc., Arlington, WA (US)

(21) Appl. No.: 12/397,310

(22) Filed: Mar. 3, 2009

Related U.S. Application Data
(60) Provisional application No. 61/033,286, filed on Mar. 3, 2008.
(60) Provisional application No. 61/102,447, filed on Oct. 3, 2008.

(51) Int. Cl. C08J 9/00; C08J 9/12; B29C 44/34

(52) U.S. Cl. 264/50; 521/50; 521/182; 521/143; 521/149; 521/82

(57) ABSTRACT

Disclosed herein are methods for making expanded foamed polymeric panels from solid monolithic semi-crystalline thermoplastic material sheets having a first thickness, density, and volume. In one embodiment, the method comprises: absorbing an effective amount of a plasticizing gas into the semi-crystalline thermoplastic material sheet to yield a reversibly plasticized semi-crystalline thermoplastic material sheet that is differentially impregnated with the plasticizing gas to define a non-uniform gas concentration gradient across the initial first thickness; and heating the plasticized semi-crystalline thermoplastic sheet to yield the foamed polymeric panel, wherein the foamed polymeric panel comprises (1) a second thickness that is at least about three and half times greater than the first initial thickness, and (2) a non-uniform second density level that is less than the first density level. In another embodiment, the foamed polymeric panel also comprises (3) a second volume that is at least 5 times greater than the first volume.

### CROSS-REFERENCE TO RELATED APPLICATIONS

This application claims the benefit of U.S. Provisional Application No. 61/033,286 filed on Mar. 3, 2008, which application is incorporated herein by reference in its entirety for all purposes.

### TECHNICAL FIELD

The present invention relates generally to foamed plastic materials and, more specifically, to foamed semi-crystalline thermoplastic material panels and structures having a layered structure, as well as to methods of making the same.

### BACKGROUND OF THE INVENTION

Microcellular plastic foam refers to a polymer that has been specially foamed to thereby create micro-pores or cells (also sometime referred to as bubbles). The common definition includes foams having an average cell size on the order of 10 microns in diameter, and typically ranging from about 0.1 to about 100 microns in diameter. In comparison, conventional plastic foams typically have an average cell diameter ranging from about 100 to 500 microns. Because the cells of microcellular plastic foams are so small, to the casual observer these specialty foams generally retain the appearance of a solid plastic.

Microcellular plastic foams can be used in many applications such as, for example, insulation, packaging, structures, and filters (D. Klempner and K. C. Fritsch, eds., Handbook of Polymeric Foams and Foam Technology, Hanser Publishers, Munich (1991)). Microcellular plastic foams have many unique characteristics. Specifically, they offer good mechanical properties and a reduction on material costs and weights at the same time. This is one of the advantages of microcellular foams over conventional foams in which weight reduction is generally achieved at the expense of reduced mechanical properties. Moreover, in conventional foam production technology, ozone-damaging chloroflourocarbons (CFCs) or hydrochlorofluorocarbons (HCFCs), as well as flammable hydrocarbons are typically used as foaming agents. Microcellular foam processing technology, on the other hand, has the additional advantage of using environmentally friendly foaming agents such as, for example, carbon dioxide and nitrogen.

The process of making microcellular plastic foams has been developed based on a thermodynamic instability causing cell nucleation (J. E. Martini, SM Thesis, Department of Mech. Eng., MIT, Cambridge, Mass. (1981)). First, a polymer is saturated with a volatile foaming agent at a high pressure. Then, by means of a rapid pressure drop, the solubility of foaming agent in the polymer is decreased, and the polymer becomes supersaturated. The system is heated to soften the polymer matrix and a large number of cells are nucleated. The foaming agent diffuses both outwards and into a large number of small cells. Stated somewhat differently, microcellular plastic foam may be produced by saturating a polymer with a gas or supercritical fluid and using a thermodynamic instability, typically a rapid pressure drop, to generate billions of cells per cubic centimeter (i.e., bubble density of greater than 10⁸ cells per cubic centimeter) within the polymer matrix.

There are several patents and patent publications that disclose various aspects of microcellular plastic foam and processes for making the same. Exemplary in this regard are the following:

U.S. Pat. No. 4,473,665 to Martini-Vvedensky et a. (issued Sep. 25, 1984) discloses microcellular plastic foams and related methods. In this patent, a batch process is disclosed in which a plastic sheet or other article is impregnated with an inert gas under pressure; the pressure is reduced to ambient; the plastic sheet or article is heated to a softening point to initiate bubble nucleation and foaming; and when the desired degree of foaming has been achieved, the plastic sheet or article is quenched to terminate foaming. The resulting product is a microcellular plastic foam having uniformly distributed cells all of about the same size.

U.S. Pat. No. 4,761,256 to Hardenbrook et a. (issued Mar. 1, 1998) discloses a process in which a web of plastic material is impregnated with an inert gas and the gas is diffused out of the web in a controlled manner. The web is reheated at a station external to the extruder to induce foaming, wherein the temperature and duration of the foaming process is controlled so as to produce uniformly distributed cells. The process is designed to provide for the continuous production of microcellular foamed plastic sheet.

U.S. Pat. No. 5,158,986 to Cha et a. (issued Oct. 27, 1992) discloses the formation of microcellular plastic foams by using a supercritical fluid as a blowing agent. In a batch process, a plastic article is submerged at pressure in a supercritical fluid for a period of time, and then quickly returned to ambient conditions so as to create a solubility change and nucleation. In a continuous process, a polymeric sheet is extruded, which can be run through rollers in a container of supercritical fluid at pressure, and then exposed quickly to ambient conditions. In another continuous process, a supercritical fluid-saturated molten polymeric stream is established. The polymeric stream is rapidly heated, and the resulting thermodynamic instability (solubility change) creates sites of nucleation (while the system is maintained under pressure to prevent significant cell growth). The polymeric stream is then injected into a mold cavity where pressure is reduced and cells are allowed to grow.

U.S. Pat. No. 5,684,055 to Kumar et a. (issued Nov. 4, 1997) discloses a method for the semi-continuous production of microcellular foam articles. In a preferred embodiment, a roll of polymer sheet is provided with a gas channeling means interleaved between the layers of polymer. The roll is exposed to a non-reacting gas at elevated pressure for a period of time sufficient to achieve a desired concentration of gas within the polymer. The saturated polymer sheet is then separated from the gas channeling means and bubble nucleation and growth is initiated by heating the polymer sheet. After foaming, bubble nucleation and growth is quenched by cooling the foamed polymer sheet.

U.S. Patent Application Publication No. US200/0203198 to Branch et al. (published Sep. 5, 2005) discloses a solid state process that utilizes gas impregnation (similar to that of Kumar et al.) to enhance forming and thermoforming of the thermoplastic material.

Although much progress has made with respect to the development of microcellular foamed thermoplastic material objects and articles of manufacture, there is still a need in the art for new and different types of foamed plastic materials. The present invention fulfills these needs and provides for further related advantages.

### SUMMARY OF THE INVENTION

In brief, the present invention relates to various methods for making expanded foamed polymeric panels from solid monolithic semi-crystalline thermoplastic material sheets. Thus, and in one embodiment, the invention is directed to a method for making a foamed polymeric panel from a solid monolithic semi-crystalline thermoplastic material sheet, wherein the semi-crystalline thermoplastic sheet has an initial first thickness and a uniform first density level. In this embodiment, the method comprises: absorbing an effective amount of a plasticizing gas into the semi-crystalline thermoplastic material sheet to yield a reversibly plasticized semi-crystalline thermoplastic material sheet, wherein the plasticized semi-crystalline thermoplastic material is differentially impregnated with the plasticizing gas to define a non-uniform gas concentration gradient across the initial first thickness; and heating the plasticized semi-crystalline thermoplastic sheet to yield the foamed polymeric panel, and wherein the foamed polymeric panel comprises (1) a second thickness that is at least about three and half times greater than the first initial thickness, and (2) a non-uniform second density level that is less than the first density level.

In another embodiment, the invention is directed to a method for making a foamed polymeric panel from a solid monolithic semi-crystalline thermoplastic material sheet, wherein the semi-crystalline thermoplastic sheet has an initial first thickness, a uniform first density level, and a first volume. In this embodiment, the method comprises: absorbing an effective amount of a plasticizing gas into the semi-crystalline thermoplastic material sheet to yield a reversibly plasticized semi-crystalline thermoplastic material sheet, wherein the plasticized semi-crystalline thermoplastic material is differentially impregnated with the plasticizing gas to define a non-uniform gas concentration gradient across the initial first thickness; and, heating the plasticized semi-crystalline thermoplastic sheet to yield the foamed polymeric panel, and wherein the foamed polymeric panel comprises (1) a second thickness that is at least about three and half times greater than the first initial thickness, (2) a non-uniform second density level that is less than the first density level, and (3) a second volume that is at least 5 times greater than the first volume.

These and other aspects of the present invention will become more evident upon reference to the following detailed description and attached drawings. It is to be understood, however, that various changes, alterations, and substitutions may be made to the specific embodiments disclosed herein without departing from their essential spirit and scope. In addition, it is expressly provided that all of the various references cited herein are incorporated herein by reference in their entireties for all purposes.

### BRIEF DESCRIPTION OF THE DRAWINGS

In the drawings reference numerals are used to designate the various steps associated with the innovative methods.

FIG. 1 is a block diagram of a method for making an expanded foamed polymeric panel from a solid monolithic semi-crystalline thermoplastic material sheet in accordance with an embodiment of the present invention.

### DETAILED DESCRIPTION OF THE INVENTION

The present invention relates to various methods for making expanded foamed polymeric panels from solid monolithic semi-crystalline thermoplastic material sheets. In the several embodiments disclosed herein, the expanded foamed polymeric panels are described in the context of transforming a solid monolithic sheet of polyactic acid (PLA) or polyethylene terephthalate (PET); however, it is to be understood that other semi-crystalline polymers such as, for example, polyethylene napthalate (PEN), polybutylterephthalate (PBT), polypropylene (PP), polyethylene (PE), polyhydroxyalkanoate (PHA), polyetherketoneketone (PEKK), polyetheretherketone (PEEK), polyphthalamide (PPA), polyphenylene sulfide (PPS), as well as various polymeric blends thereof, are contemplated and within the scope of the invention. In addition, and as appreciated by those skilled in the art, PET is understood to be inclusive of both RPET (recycled polyethylene terephthalate) and CPET (crystallizing polyethylene terephthalate).

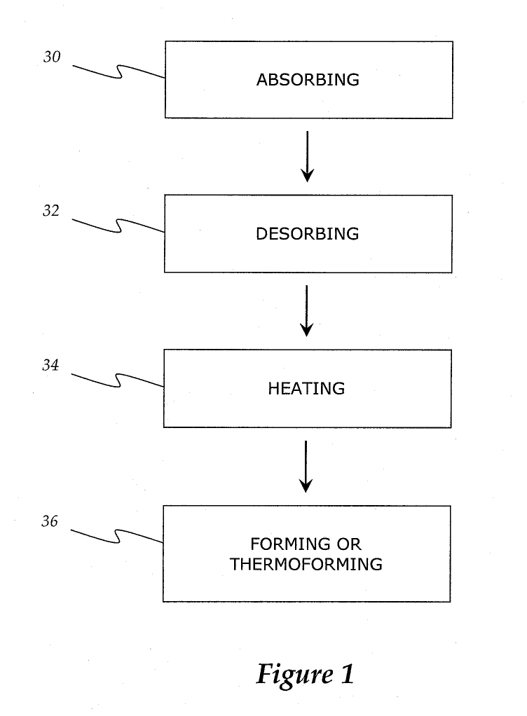

Thus, and in view of foregoing and with reference to FIG. 1, the invention in one embodiment is directed to a method for making a foamed polymeric cellular panel from a solid monolithic semi-crystalline thermoplastic material sheet. In this embodiment, the method comprises an initial absorbing step 30 whereby an effective amount of a plasticizing gas (such as, for example, CO₂ or N₂) is absorbed into the semi-crystalline thermoplastic material sheet, which sheet has an initial first thickness and a uniform first density level. The absorbing step 30 is generally accomplished by placing the thermoplastic material sheet into a pressure vessel, and then pressurizing the vessel to a first selected pressure, temperature, and for period of time sufficient to (1) yield a reversibly plasticized thermoplastic material sheet, and (2) create a non-uniform gas concentration gradient across the initial first thickness. The first selected pressure generally ranges from about 0.345 MPa to about 9.65 MPa (or more preferably about 5.2 MPa to about 7.1 MPa), and the first selected temperature generally ranges from about −20° F. to about 150° F. Depending on the selected semi-crystalline thermoplastic material, pressure and temperature, the selected period of time generally ranges from about a few hours to well over a hundred hours.

As a result of the absorbing step 30, the plasticized semi-crystalline thermoplastic material sheet becomes impregnated with the plasticizing gas in an amount that is generally greater than about 0.5 percent by weight. In this way, the plasticized thermoplastic material sheet may attain a non-uniform gas concentration gradient across the initial first thickness (meaning that immediately after the step of absorbing, and before initiating any bubble formation, the impregnated gas concentration may vary differentially across the initial first thickness such as, for example, in a step-wise fashion wherein the lowest impregnated gas concentration generally occurs at the middle portion and near the surfaces of the plasticized semi-crystalline thermoplastic material sheet).

After the absorbing step 30, the method typically further comprises a desorbing step 32, whereby a portion of the plasticizing gas impregnated within the plasticized thermoplastic sheet is allowed to diffuse out of the plasticized thermoplastic material sheet and into the atmosphere. Accordingly, the desorbing step 32 generally occurs by exposing the plasticized thermoplastic material sheet to a reduced pressure such as, for example, atmospheric pressure or lower. In order to further process the plasticized thermoplastic material sheet, it has been found that the plasticizing gas concentration within the thermoplastic material sheet should preferably be maintained at a level of greater than about 0.01 percent by weight. In addition, the desorbing step 32 generally occurs at a second selected temperature ranging from about −40° F. to about 150° F.

After the desorbing step 32, the method further comprises a heating step 34, whereby the plasticized thermoplastic material sheet is heated in order to initiate foaming (i.e., bubble formation). In this step, the plasticizing gas impregnated within the thermoplastic sheet tends to coalesce into a plurality of closed and/or open cells (i.e., bubbles). The heat source may be either a heated silicon oil bath or an infrared heater or heated press, for example. The heating step 34 yields the foamed polymeric panel, wherein the foamed polymeric panel comprises (1) a second thickness that is at least about three and half times greater than the first initial thickness, and (2) a non-uniform second density level that is less than the first density level. In another embodiment, the foamed polymeric panel also comprises (3) a second volume that is at least 5 times greater than the first volume. The foamed thermoplastic material sheet may be fully foamed, or it may only be partially foamed, after the heating step 34. Moreover, the second non-uniform density level may, on average, be no greater than about 20 percent of the uniform first density; and the second volume may be about 5 to about 33 times greater than the first volume. Thus, it has been discovered that solid-sate foaming of thick semi-crystalline sheets results in expansion predominantly in thickness direction as compared to thinner semi-crystalline sheets of the same chemistry.

Finally, and after or concurrent with the heating step 34, the method may further comprises a forming/shaping or thermoforming step 36 in which the foamed thermoplastic sheet is either cold formed or thermoformed in a thermoformer to yield the foamed polymeric panel (which panel may take the form of a shaped three-dimensional object). The forming/shaping or thermoforming step 36 generally involves the mechanical deformation of the partially or fully foamed thermoplastic material sheet into a desired shape such as, for example, the shape of a curved panel (including structural insulated panels used in building construction, roof-top carriers used on cars and trucks, as well as door inserts, luggage trays, dashboards, desktop for furniture, and the like).

For purposes of illustration and not limitation, the following example more specifically discloses exemplary process steps and actual experimental data associated with the making of a foamed polymeric panel from a solid monolithic semi-crystalline thermoplastic material sheet in accordance with the present invention.

### Example

In experiments conducted at MicroGREEN Polymers using a 0.6 mm-thick PLA sample and a 1.32 mm-thick PLA sample as the starting material, it was shown that when the samples underwent CO₂ gas-induced crystallization, the amount by which the samples expanded in the thickness dimension differed significantly. The 0.6 mm PLA specimen, which was saturated at 3 MPa for 4 hours and foamed in an infrared oven to 100 C surface temperature, increased in thickness by twofold from 0.6 mm to 1.2 mm thickness. The sample had a foamed sandwich structure consisting of smooth but thin integral outer layers with a foamed interior layer of relatively uniform microbubbles on the order of 20 micrometers in diameter. In contrast, the 1.32 mm-thick PLA sample, which was saturated at 3 MPa for 13 hours and foamed in an infrared oven to 100 C surface temperature, increased almost 4.5 times in thickness from 1.32 mm to 6.0 mm thickness. The sample had a foamed sandwich structure consisting of very thick and highly crystalline integral outer layers, of approximate thickness 250 μm and with a few rare large 50 μm bubbles. Immediately adjacent to the outer layers was a transitional layer of 20-50 μm bubbles. The innermost core contained macro bubbles ranging from 250 μm to 1 mm in diameter. From a 1.32 mm-thick PLA sample to a 6.0 mm-thick cellular foam panel, this highly economical sandwich structure achieved upwards to 90% density reduction while giving the panel its superior flexural stiffness, compressive and buckling performance. Similar results were seen in other thick semi-crystalline polymer materials like PET and PP. For example, when a 1.27 mm-thick PET sample was exposed to high pressure CO₂ gas for 50 hours, the surface layers became extremely thick and crystalline while the internal layers lessened in density with bubbles that grew progressively larger as they neared the center.

While the present invention has been described in the context of the embodiments illustrated and described herein, the invention may be embodied in other specific ways or in other specific forms without departing from its spirit or essential characteristics.

Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

1. A method for making a foamed polymeric panel from a solid monolithic semi-crystalline thermoplastic material sheet, the semi-crystalline thermoplastic sheet having an initial first thickness and a uniform first density level, the method comprising:
absorbing an effective amount of a plasticizing gas into the semi-crystalline thermoplastic material sheet to yield a reversibly plasticized semi-crystalline thermoplastic material sheet, wherein the plasticized semi-crystalline thermoplastic material is differentially impregnated with the plasticizing gas to define a non-uniform gas concentration gradient across the initial first thickness; and
heating the plasticized semi-crystalline thermoplastic sheet to yield the foamed polymeric panel, and wherein the foamed polymeric panel comprises (1) a second thickness that is at least about three and half times greater than the first initial thickness, and (2) a non-uniform second density level that is less than the first density level.

2. The method according to claim 1 wherein the semi-crystalline thermoplastic material sheet is selected from the group consisting of polyethylene terephthalate (PET), polyactic acid (PLA), polyethylene napthalate (PEN), polybutylterephthalate (PBT), polypropylene (PP), polyethylene (PE), polyhydroxyalkanoate (PHA), polyetherketoneketone (PEKK), polyetheretherketone (PEEK), polyphthalamide (PPA), polyphenylene sulfide (PPS), and blends thereof.

3. The method according to claim 1 wherein the semi-crystalline thermoplastic material sheet is polyactic acid (PLA).

4. The method according to claim 1 wherein the semi-crystalline thermoplastic material sheet is polyethylene terephthalate (PET).

5. The method according to claim 3 wherein the plasticizing gas is carbon dioxide (CO2).

6. The method according to claim 4 wherein the plasticizing gas is carbon dioxide (CO2).

7. The method according to claim 2 wherein the foamed polymeric panel comprises smooth outer unfoamed surface layers sandwiching one or more inner foamed layers.

8. The method according to claim 7 wherein the one or more inner foamed layers comprises a plurality of closed cells, wherein the plurality of closed cells have an average cell diameter ranging from about 5 to about 1,000 microns.

9. The method according to claim 8 wherein the plurality of closed cell are, on average, largest at the middle portion of the foamed polymeric panel.

10. The method according to claim 8 wherein the plurality of closed cell define a non-uniform average cell size gradient across the second thickness, wherein the largest average cell size occurs at the middle portion of the foamed polymeric panel.

11. The method according to claim 10 wherein the second non-uniform density level is, on average, no greater than about 20 percent of the uniform first density level.

12. The method according to claim 1 wherein the solid monolithic semi-crystalline thermoplastic material sheet is non-planar.

13. The method according to claim 1, further comprising a step of desorbing at least some of the plasticizing gas from the plasticized semi-crystalline thermoplastic material sheet, wherein the step of desorbing occurs after the step of absorbing.

14. The method according to claim 13, further comprising a step of thermoforming the plasticized semi-crystalline thermoplastic sheet, wherein the step of thermoforming occurs after the step of desorbing.

15. The method according to claim 13, further comprising a step of thermoforming the plasticized semi-crystalline thermoplastic sheet, wherein the step of thermoforming occurs at the same time as the step of heating.

16. The method according to claim 15, further comprising a step of quenching the plasticized semi-crystalline thermoplastic sheet, wherein the step of quenching occurs after the step of thermoforming.

17. The method according to claim 13, further comprising a step of thermoforming the plasticized semi-crystalline thermoplastic sheet, wherein the step of thermoforming occurs after the step of heating.

18. The method according to claim 17 wherein the foamed polymeric panel is closed cell and microcellular.

19. A method for making a foamed polymeric panel from a solid monolithic semi-crystalline thermoplastic material sheet, the semi-crystalline thermoplastic sheet having an initial first thickness, a uniform first density level, and a first volume, the method comprising:
absorbing an effective amount of a plasticizing gas into the semi-crystalline thermoplastic material sheet to yield a reversibly plasticized semi-crystalline thermoplastic material sheet, wherein the plasticized semi-crystalline thermoplastic material is differentially impregnated with the plasticizing gas to define a non-uniform gas concentration gradient across the initial first thickness; and
heating the plasticized semi-crystalline thermoplastic sheet to yield the foamed polymeric panel, and wherein the foamed polymeric panel comprises (1) a second thickness that is at least about three and half times greater than the first initial thickness, (2) a non-uniform second density level that is less than the first density level, and (3) a second volume that is at least 5 times greater than the first volume.

20. The method according to claim 19 wherein the second non-uniform density level is, on average, no greater than about 20 percent of the uniform first density level.

21. The method according to claim 20 wherein the second volume is about 5 to about 33 times greater than the first volume.
